(19) United States
(12) Patent Application Publication
(10) Pub. No.: US 2004/0228078 A1
(43) Pub. Date: Nov. 18, 2004

(54) Coupling apparatus and a coupling method

(75) Inventors: Eigo Shimizu, Tokyo (JP); Toshikazu Karita, Tokyo (JP)

Correspondence Address: BURNS DOANE SWECKER & MATHIS L L P, POST OFFICE BOX 1404, ALEXANDRIA, VA, 22313-1404, US

(73) Assignee: MITSUBISHI DENKI KABUSHIKI KAISHA.

(21) Appl. No.: 10/688,971

(22) Filed: Oct. 21, 2003

(30) Foreign Application Priority Data
Dec. 12, 2002 (JP) JP2002-360706

(51) Int. Cl. G06F 1/16

(52) U.S. Cl. 361/682

(57) ABSTRACT

As a method for maintaining a frame having a mask, at a predetermined position inside a panel of a color cathode-ray tube, provided are a first plate type—elastic body which is fixed to the panel through a stud pin adhering to the panel, a second plate type—elastic body which is fixed to the frame, a third plate type—elastic body which is provided between the first plate type—elastic body and the second plate type—elastic body, a bent part, protruding in the direction of the first plate type—elastic body, which is provided in a part of the third plate type—elastic body, a space being equal to or less than 1.0 mm between the bent part and a slant plane of the first plate type—elastic body, and a space being equal to or less than 1.0 mm between an end part of the third plate type—elastic body and the second plate type—elastic body.

### BACKGROUND OF THE INVENTION

1. Field of the Invention

The present invention relates to a coupling apparatus and a coupling method. For instance, it relates to a coupling apparatus and a coupling method for coupling a panel with a frame of a color cathode-ray tube used for a television, a display, etc.

2. Description of Related Art

FIGS. 6, 7, and 8 show structures of a conventional color cathode-ray tube including a supporting member described, for example, in Unexamined Japanese Patent Publication No. 63-158731. FIG. 6 shows a sectional view of the conventional color cathode-ray tube including the supporting member, FIG. 7 shows an enlarged view around the supporting member of the conventional color cathode-ray tube, and FIG. 8 shows an enlarged view of the supporting member of the conventional color cathode-ray tube. In these figures, the following are provided: a panel 1, a phosphor 2 provided inside the panel, an electron gun 3, a mask 4 allowing an electron beam to penetrate, a funnel 5, and a frame 6 for supporting the mask.

The frame 6 is fixed to a stud pin 9 provided on the panel 1, through the supporting member composed of elements 7 and 8. The element 7 is a fixed part adhering to the frame 6 and the element 8 is a plate type—elastic body. As shown in FIG. 9 or 10, the supporting members are provided at the four corners of the frame or near the center of each side of the frame.

In the color cathode-ray tube configured above, when coupling an end of the supporting member, which is V or U shaped and includes a plate type—elastic body, to a frame and the other end of the supporting member to a panel, a color shifting and an uneven coloring (called mislanding) can be avoided by appropriately designing the supporting member in order to perform a compensation of beam landing to move the frame in the axial direction of the valve, utilizing thermal expansion of the frame.

Bimetal made of two metals of different thermal expansion rates can be used for the supporting member, or optimizing the bending angle of the plate type elastic body can be performed for the supporting member. The mislanding results from the state that an electron beam having penetrated the mask is not irradiated onto a suitable position on the phosphor due to the thermal expansion of the frame. Comparing the case of the supporting member of V or U shape being provided at the four corners of the frame with the case of the supporting member being provided near the center of each side of the frame, influence of the frame deformation by the thermal expansion is less in the case of being provided at the four corners.

Mislanding may occur when a permanent deformation is applied on some part of the supporting member by a load of an impact force against the cathode-ray tube. As the plate type component used for the supporting member has elasticity in the conventional structure, when an impact force load is applied on the main body, it is possible to reduce the permanent deformation in order not to result in the mislanding, because the elasticity absorbs most of the impact force.

In the case of the supporting member shown in FIG. 11, it is structured so that the fixed part can be easily separated from the frame at the end part of the supporting member and the impact force can be easily absorbed by the whole of the supporting member. In the case of the structure of the supporting member shown in FIG. 12, the fixed part is designed as the elastic body, which further mitigates the impact force.

The related art of the present invention is Japanese Unexamined Patent Publication No. 63-158731.

In order to satisfy the expectation for images of high luminance and high clearance of the television and the display, it is needed to more strictly maintain the frame at a predetermined position. Even if a supporting member which can accurately perform the above-mentioned beam landing compensation is designed, when a stronger impact force is applied, it is not necessarily possible for the supporting member to keep the elasticity almost completely and to absorb the impact force so as to maintain the frame at the predetermined position. That is, a permanent deformation may be applied on some part of the supporting member and the relative position between the frame and the stud pin may be shifted, which will result in the mislanding.

On the other hand, when a load of the impact force is applied onto the cathode-ray tube through the supporting member, in addition to the load in the bending direction, rotation moment around the plane attaching to the frame is applied onto the elastic body. Therefore, in the supporting member as shown in FIGS. 8, 11 and 12, local stress concentration is generated at bent parts A, B, C, D and E. Consequently, there is a possibility that permanent deformation occurs in the elastic body of plate type. Moreover, since the elastic body, as a spring, is prone to be worn out at these bent parts A through E in processing and assembling, the permanent deformation due to the impact force tends to occur. Accordingly, it becomes impossible to maintain the frame at the predetermined position. Thus, it is impossible to irradiate a beam onto the suitable position of the phosphor, which results in a problem of the color shifting or uneven coloring.

### SUMMARY OF THE INVENTION

It is one of objects of the present invention, in order to solve the above stated problem, to prevent the color shifting and the uneven coloring caused by mislanding resulting from a permanent deformation of the supporting member, even when a load of an impact force is applied onto the cathode-ray tube.

According to one aspect of the present invention, a coupling apparatus for coupling a first structure with a second structure comprises:

a first coupling part having one end and other end and coupled to the first structure; and a second coupling part having one end and other end, coupled to the second structure, and including a projection portion, protruding in a predetermined direction, between the one end and the other end,

wherein the one end of the first coupling part adheres to the one end of the second coupling part, and the other end of the second coupling part is located to be a predetermined distance away from the other end of the first coupling part, and

the first coupling part and the second coupling part are arranged so that the projection portion of the second coupling part may protrude in a direction of the first coupling part and a distance between a specific portion of the first coupling part and the projection portion of the second coupling part may be equal to or less than one-tenth of a distance between the other end of the first coupling part and the other end of the second coupling part.

According to another aspect of the present invention, a coupling method for coupling a first structure with a second structure, by using a first coupling part which has one end and other end and is coupled to the first structure and a second coupling part which has one end and other end, is coupled to the second structure, and includes a projection portion, protruding in a predetermined direction, between the one end and the other end, the coupling method comprises:

making the one end of the first coupling part adhere to the one end of the second coupling part;

locating the other end of the second coupling part to be a predetermined distance away from the other end of the first coupling part; and

arranging the first coupling part and the second coupling part so that the projection portion of the second coupling part may protrude in a direction of the first coupling part, and a distance between a specific portion of the first coupling part and the projection portion of the second coupling part may be equal to or less than one-tenth of a distance between the other end of the first coupling part and the other end of the second coupling part.

The above-mentioned and other objects, features, and advantages of the present invention will be made more apparent by reference to the following detailed description when taken in conjunction with the accompanying drawings.

### BRIEF DESCRIPTION OF THE DRAWINGS

In the drawings,

FIG. 1 shows an enlarged view around a supporting member of a color cathode-ray tube according to Embodiment 1 of the present invention;

FIG. 2 shows a sectional view of the color cathode-ray tube according to Embodiment 1 of the present invention;

FIG. 3 shows an enlarged view of the supporting member of the color cathode-ray tube according to Embodiment 2 of the present invention;

FIG. 4 illustrates the case of an impact force acting on the color cathode-ray tube according to Embodiment 1 of the present invention;

FIG. 5 shows an enlarged view of the supporting member of the color cathode-ray tube according to Embodiment 1 of the present invention and illustrates the state of an impact force acting on the color cathode-ray tube;

FIG. 6 shows a sectional view of a conventional color cathode-ray tube;

FIG. 7 shows an enlarged view around the supporting member of the conventional color cathode-ray tube;

FIG. 8 shows an enlarged view of the supporting member of the conventional color cathode-ray tube;

FIG. 9 shows a front view of the case of four corners of a frame of a color cathode-ray tube being supported;

FIG. 10 shows a front view of the case of almost the center of each side of a frame of a color cathode-ray tube being supported;

FIG. 11 shows an enlarged view of the supporting member of the conventional color cathode-ray tube;

FIG. 12 shows an enlarged view of the supporting member of the conventional color cathode-ray tube;

FIG. 13 shows an enlarged view of the supporting member of the color cathode-ray tube according to Embodiment 2 of the present invention;

FIG. 14 shows an enlarged view of the supporting member of the color cathode-ray tube according to Embodiment 2 of the present invention; and

FIG. 15 shows an enlarged view of the supporting member of the color cathode-ray tube according to Embodiment 4 of the present invention.

### DETAILED DESCRIPTION OF PREFERRED EMBODIMENTS

### Embodiment 1

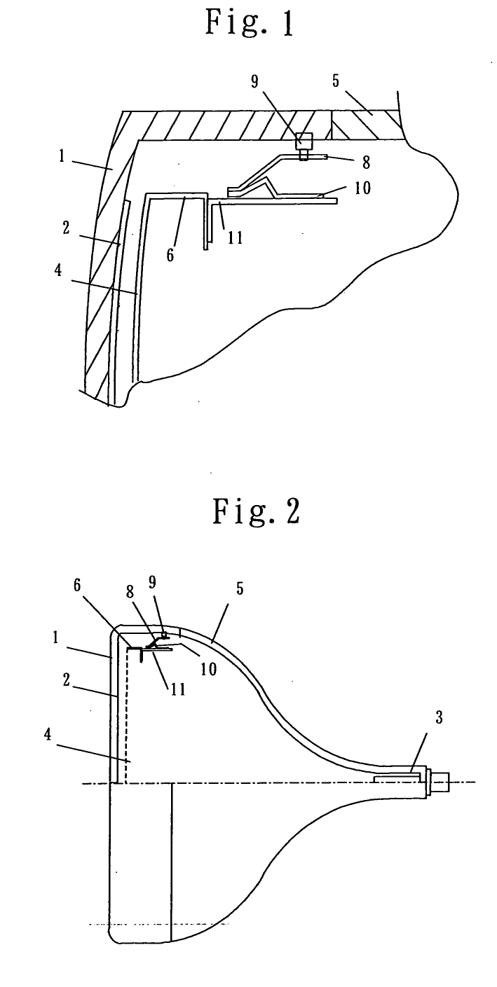

FIG. 1 shows an enlarged view around a supporting member of a color cathode-ray tube according to Embodiment 1 of the present invention, and FIG. 2 shows a sectional view of the whole color cathode-ray tube including the supporting member. In FIGS. 1 and 2, the following are provided: a panel 1, a phosphor 2 provided inside the panel, an electron gun 3, a mask 4 allowing an electron beam to penetrate, a funnel 5, and a frame 6 for supporting the mask. The frame 6 is fixed to a stud pin 9 provided on the panel 1, through the supporting member composed of elements 8, 10 and 11 being plate type—elastic body. In the supporting member, the plate type—elastic bodies 8 and 10, as a whole, form a bent part of approximately V or U shaped. One side (the plate type—elastic body 10) adheres to the plate type—elastic body 11 whose one side adheres to the frame, and other side (the plate type—elastic body 8) is fixed to the stud pin 9 adhering to the inside of the panel.

In Embodiment 1, the panel 1 corresponds to an example of a first structure, and the frame 6 corresponds to an example of a second structure. The combination of the plate type—elastic body 8 and the plate type—elastic body 10 corresponds to an example of a coupling apparatus, the plate type—elastic body 8 corresponds to an example of a first coupling part which is coupled to the panel 1 being the first structure, and the plate type—elastic body 10 corresponds to an example of a second coupling part which is coupled to the frame 6 being the second structure, through the plate type—elastic body 11.

The plate type—elastic body 8 has an end (the end on the left side of FIG. 1) and the other end (the end on the right side of FIG. 1). The plate type—elastic body 10 also has an end (the end on the left side of FIG. 1) and the other end (the end on the right side of FIG. 1). An end of the plate type—elastic body 8 adheres to an end of the plate type—elastic body 10, and the other end of the plate type—elastic body 8 and the other end of the plate type—elastic body 10 are located to be a predetermined distance away each other. Moreover, a projection portion protruding in the direction of the plate type—elastic body 8 is provided on (between the ends of) the plate type—elastic body 10. It is configured so that the distance between the closest portion of the elastic body 8 to the projection portion of the plate type—elastic body 10, and the projection portion of the plate type—elastic body 10 may be one-tenth of the distance between the other end of the plate type—elastic body 8 and the other end of the plate type—elastic body 10. Concretely, the distance between the closest portion of the plate type—elastic body 8 to the projection portion of the elastic body 10, and the projection portion of the elastic body 10 is to be equal to or less than 1.0 mm (desirably, equal to or less than 0.4 mm).

Moreover, a space is provided between one end of the plate type—elastic body 10 and the plate type—elastic body 11. The width of this space is configured to be one-tenth of the distance between the other end of the plate type—elastic body 8 and the other end of the plate type—elastic body 10. Concretely, the width of this space is to be equal to or less than 1.0 mm (desirably, equal to or less than 0.4 mm).

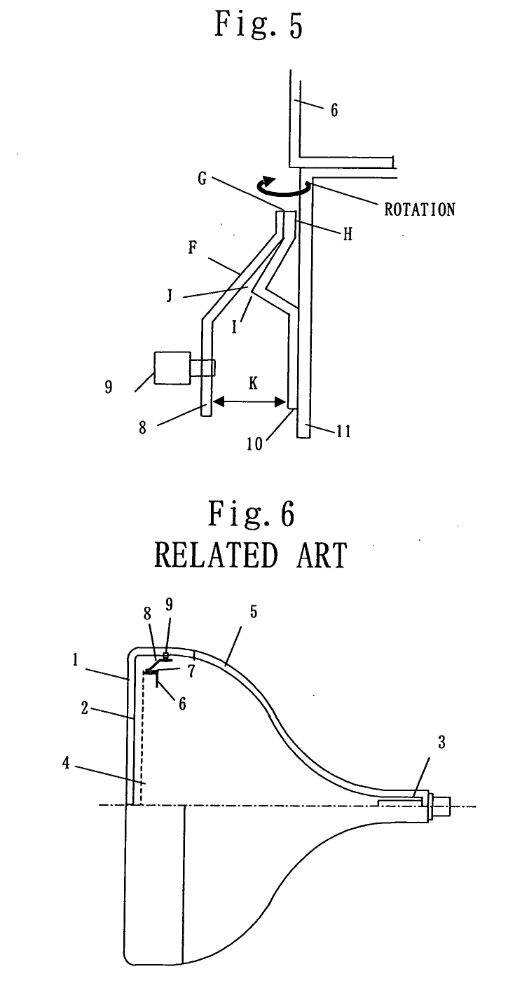

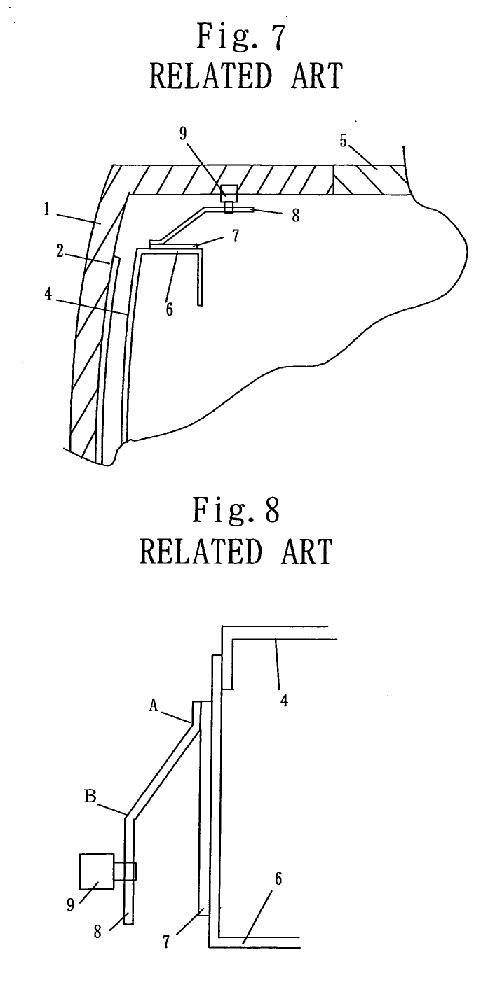

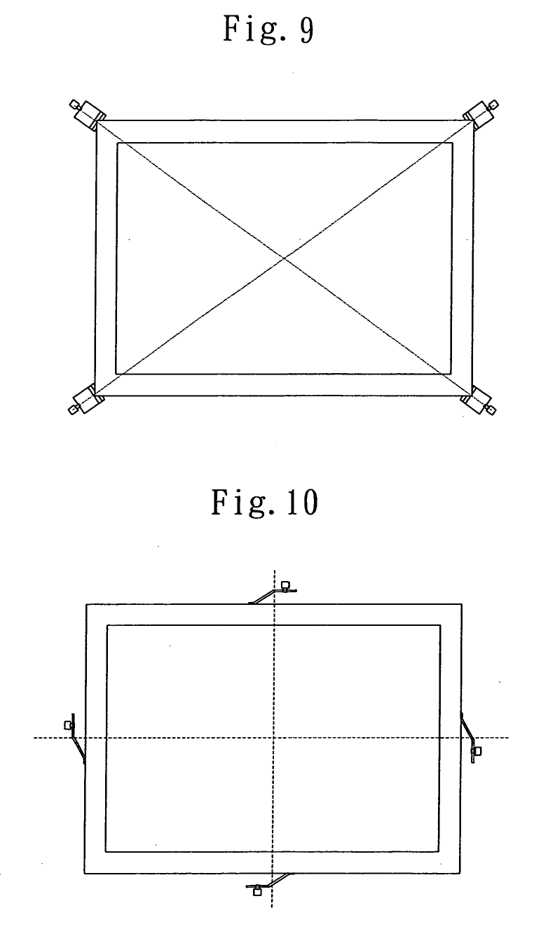

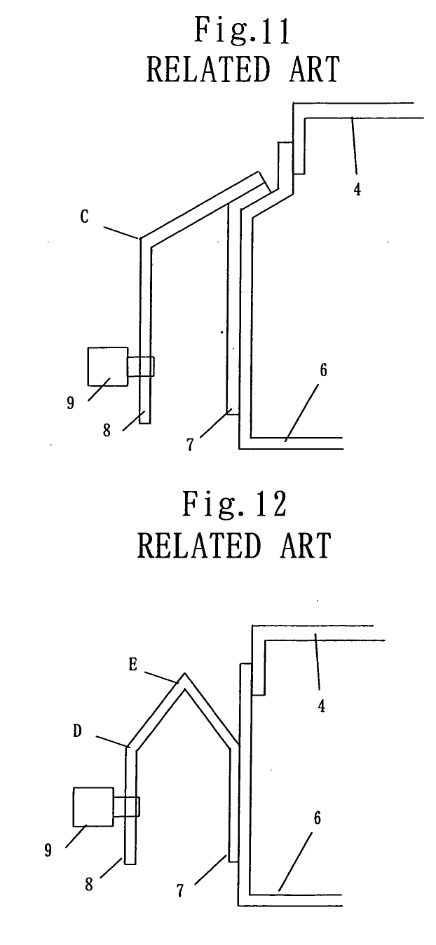

In the color cathode-ray tube configured as mentioned above, when a load of an impact force is applied onto the cathode-ray tube, the frame having rigidity much higher than that of the supporting member moves almost like a rigid body and the rotation moment acts on the supporting member as shown in FIGS. 4 and 5. Thereby, bending in the direction of the spring and twisting around the portion of the supporting member attaching to the frame occur on the supporting member. A stress concentration is generated at the bent part of the plate type—elastic body, with the slant plane F keeping almost straight. Against the impact force of a certain amount, in addition to a spring feature of the plate type—elastic body 8, the plate type—elastic body 10 has a function of mitigating the twisting because a space H is provided between an end part G of the supporting member and the plate type—elastic body 11. The width of the space H is equal to or less than one-tenth of a distance K, that is equal to or less than 1.0 mm, desirably equal to or less than 0.4 mm.

However, against the impact having a force more than the above certain amount, a stress over the elastic limit is generated in the stress concentration part, which becomes a factor of the permanent deformation. Before coming to such a state, a space J near the center of the slant plane F becomes narrow and the slant plane F of the plate type—elastic body 8 and a bent part (projection portion) I of the plate type—elastic body 10 come into contact each other. Then, the slant plane F curved and a stress distribution is mitigated by the whole slant plane of the plate type—elastic body 8. The space J near the center of the slant plane F is equal to or less than one-tenth of the distance K, that is equal to or less than 1.0 mm, and desirably equal to or less than 0.4 mm.

Besides, because of the contact of the slant plane F of the plate type—elastic body 8 with the bent part (projection portion) I of the plate type—elastic body 10, the following effects are brought: the rigidity of the plate type—elastic body 8 and the plate type—elastic body 10 as a double-ply spring is increased, and the damper effect is generated by the friction. Therefore, the deformation is restrained by these effects. The same sort of effects as the above-mentioned rigidity increase effect and the friction effect can be obtained when the space H becomes narrow and the end part G of the supporting member and the plate type—elastic body 11 come into contact each other at almost the same time as the contact of the slant plane F with the bent part I.

According to the present Embodiment, the effects stated below can be obtained.

In the color cathode-ray tube including the supporting member of the present Embodiment, it is possible to maintain the frame at the predetermined position inside the panel even when a load of the impact force is applied onto the color cathode-ray tube, which reduces the uneven coloring and the color shifting caused by the mislanding.

Moreover, at the time of installing the frame in the inner side of the panel, an impact force against the cathode-ray tube can be absorbed by providing the supporting member including one or more than one plate type—elastic body.

Furthermore, in the supporting member including one or more than one plate type—elastic body, the twisting generated on the supporting member can be mitigated because the elastic body is processed or assembled to form an angle of approximately V or U shape and the space between the end part of the elastic body and the plane attaching to the frame is from 0.0 mm to 0.4 mm. Besides, the impact force can be absorbed because of the rigidity increase and the damper effect due to the contact of the end part of the elastic body with the plane attaching to the frame.

Moreover, in the supporting member including one or more than one elastic body of plate type, since the elastic body is formed to be an angle of V or U shape and the space between the end part of the elastic body and the plane attaching to the frame is from 0.0 mm to 0.4 mm, the impact force can be absorbed by the effect of mitigating the stress by making the slant plane part curved, the rigidity increase effect as a double-ply spring, and the damper effect due to the contact, when the twisting is generated in the supporting member.

### Embodiment 2

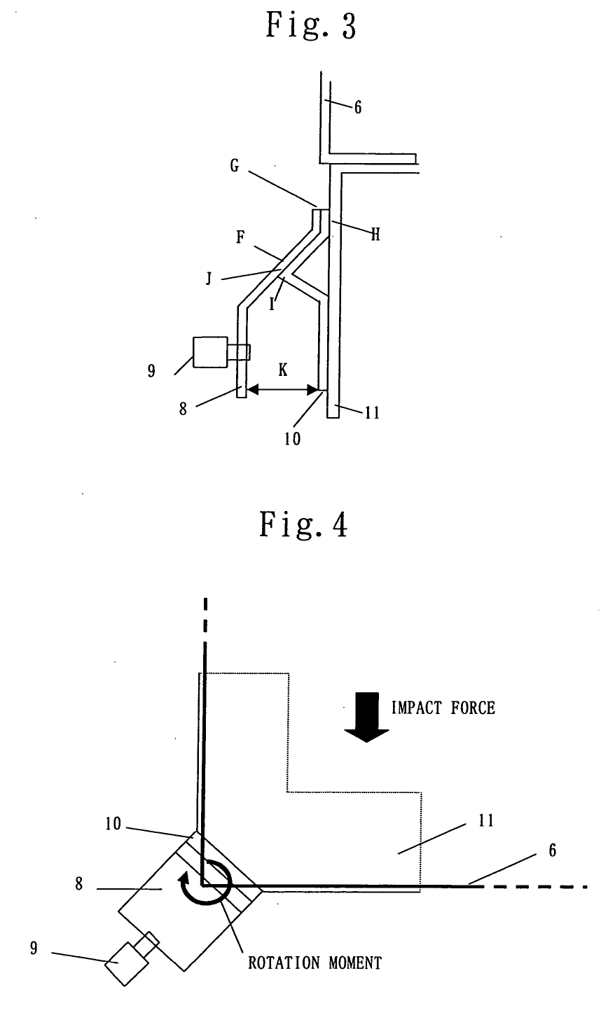

According to Embodiment 1, when twisting is generated in the supporting member, the impact force can be received by the whole supporting member because the space is provided between the end part G of the supporting member and the plate type—elastic body 11 in order not to make the rotation influential. FIG. 3 shows an enlarged view of the supporting member according to Embodiment 2. According to Embodiment 2, though the space H explained in Embodiment 1 is set to be nearly 0 mm, if twisting is generated, the twisting mitigation effect almost the same as that in Embodiment 1 can be attained because the end part G of the supporting member does not adhere to the plate type—elastic body 11 (that is, one end of the plate type—elastic body 10 is in contact, not adhering, with the plate type—elastic body 11). Therefore, when twisting is generated, the end part G separates from the plate type—elastic body 11 and the same sort of effect as the above mentioned twist mitigating effect can be obtained. Moreover, as the space J between the slant plane F of the plate type—elastic body 8 and the bent part I of the plate type—elastic body 10 is set to be nearly 0 mm (that is, the slant plane F of the plate type—elastic body 8 is in contact, not adhering, with the projection portion of the plate type—elastic body 10), the stress mitigation effect obtained by making the slant plane F of the plate type—elastic body 8 curved and the rigidity increase effect obtained by the double-ply spring can be attained from the beginning time of the impact force being applied.

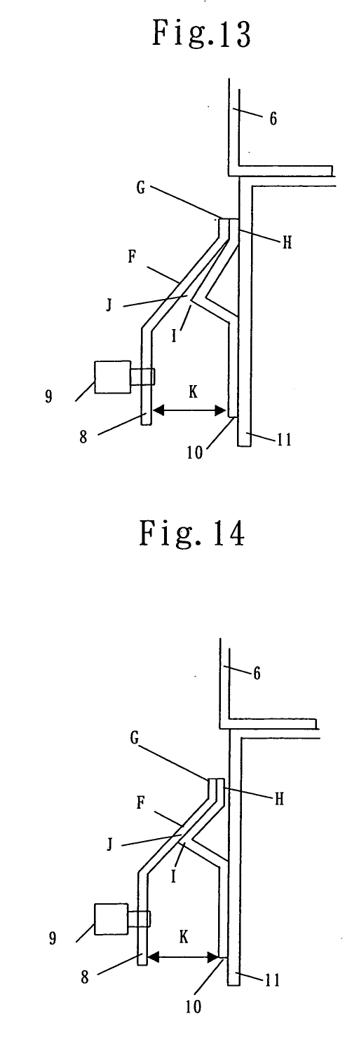

Furthermore, as shown in FIG. 13, the same stress mitigation effect and the rigidity increase effect as stated above can also be attained by making the space J between the slant plane F of the plate type—elastic body 8 and the bent part I of the plate type—elastic body 10 be equal to or less than one-tenth of the distance K, that is equal to or less than 1.0 mm, desirably equal to or less than 0.4 mm, and making the space H between the end part G of the supporting member and the plate type—elastic body 11 be nearly 0 mm.

Moreover, as shown in FIG. 14, the same stress mitigation effect and the rigidity increase effect as stated above can also be attained by making the space J between the slant plane F of the plate type—elastic body 8 and the bent part I of the plate type—elastic body 10 be nearly 0 mm, and making the space H between the end part G of the supporting member and the plate type—elastic body 11 be equal to or less than one-tenth of the distance K, that is equal to or less than 1.0 mm, desirably equal to or less than 0.4 mm.

### Embodiment 3

Almost the same effect as the above can also be attained even when the plate type—elastic body 10 and the plate type—elastic body 11 according to Embodiments 1 and 2 are formed to be one component.

### Embodiment 4

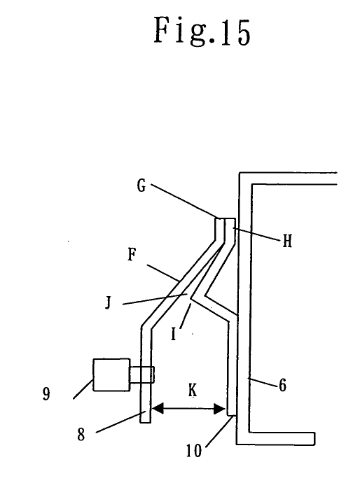

As shown in FIG. 15, even when the plate type—elastic body 8 and the plate type—elastic body 10 are directly fixed to the frame 6 without using the plate type—elastic body 11, almost the same effect as the above can also be attained.

In the above stated Embodiments from 1 to 4, the case of coupling the panel with the frame of the color cathode-ray tube has been described as an example. Besides, the coupling apparatus and the coupling method according to the present invention can also be utilized for coupling other structure objects.

According to the present invention, even when an impact force acts on the first structure and the second structure, as the first coupling part and the second coupling part effectively absorb the impact force, it is possible to maintain the first structure and the second structure at the predetermined position.

Having thus described several particular embodiments of the invention, various alterations, modifications, and improvements will readily occur to those skilled in the art. Such alterations, modifications, and improvements are intended to be part of this disclosure, and are intended to be within the spirit and scope of the invention. Accordingly, the foregoing description is by way of example only, and not intended to be limiting. The invention is limited only as defined in the following claims and the equivalents thereto.

What is claimed is:

1. A coupling apparatus for coupling a first structure with a second structure comprising:
a first coupling part having one end and other end and coupled to the first structure; and
a second coupling part having one end and other end, coupled to the second structure, and including a projection portion, protruding in a predetermined direction, between the one end and the other end,
wherein the one end of the first coupling part adheres to the one end of the second coupling part, and the other end of the second coupling part is located to be a predetermined distance away from the other end of the first coupling part, and
the first coupling part and the second coupling part are arranged so that the projection portion of the second coupling part may protrude in a direction of the first coupling part and a distance between a specific portion of the first coupling part and the projection portion of the second coupling part may be equal to or less than one-tenth of a distance between the other end of the first coupling part and the other end of the second coupling part.

2. The coupling apparatus of claim 1, wherein the first coupling part and the second coupling part are arranged so that a distance between a closest portion of the first coupling part to the projection portion of the second coupling part, and the projection portion of the second coupling part may be equal to or less than one-tenth of the distance between the other end of the first coupling part and the other end of the second coupling part.

3. The coupling apparatus of claim 2, wherein the first coupling part and the second coupling part are arranged so that the distance between the closest portion of the first coupling part to the projection portion of the second coupling part, and the projection portion of the second coupling part may be equal to or less than 1.0 mm.

4. The coupling apparatus of claim 2, wherein the first coupling part and the second coupling part are arranged so that the closest portion of the first coupling part to the projection portion of the second coupling part, may be in contact, not adhering, with the projection portion of the second coupling part.

5. The coupling apparatus of claim 1, wherein a distance between the one end of the second coupling part and the second structure is equal to or less than one-tenth of the distance between the other end of the first coupling part and the other end of the second coupling part.

6. The coupling apparatus of claim 5, wherein the distance between the one end of the second coupling part and the second structure is equal to or less than 1.0 mm.

7. The coupling apparatus of claim 5, wherein the one end of the second coupling part is in contact, not adhering, with the second structure.

8. The coupling apparatus of claim 1, wherein the second coupling part is coupled to the second structure through a plate type—elastic body adhering to the other end of the second coupling part, and a distance between the one end of the second coupling part and the plate type—elastic body is equal to or less than one-tenth of the distance between the other end of the first coupling part and the other end of the second coupling part.

9. The coupling apparatus of claim 8, wherein the distance between the one end of the second coupling part and the plate type—elastic body is equal to or less than 1.0 mm.

10. The coupling apparatus of claim 8, wherein the one end of the second coupling part is in contact, not adhering, with the plate type—elastic body.

11. The coupling apparatus of claim 1, wherein at least one of the first coupling part and the second coupling part is the plate type—elastic body.

12. The coupling apparatus of claim 1, wherein the coupling apparatus couples a panel of a cathode-ray tube with a frame of the cathode-ray tube, the first coupling part is coupled to the panel being the first structure, and the second coupling part is coupled to the frame being the second structure.

13. A coupling method for coupling a first structure with a second structure, by using a first coupling part which has one end and other end and is coupled to the first structure and a second coupling part which has one end and other end, is coupled to the second structure, and includes a projection portion, protruding in a predetermined direction, between the one end and the other end, the coupling method comprising:
making the one end of the first coupling part adhere to the one end of the second coupling part;
locating the other end of the second coupling part to be a predetermined distance away from the other end of the first coupling part; and
arranging the first coupling part and the second coupling part so that the projection portion of the second coupling part may protrude in a direction of the first coupling part, and a distance between a specific portion of the first coupling part and the projection portion of the second coupling part may be equal to or less than one-tenth of a distance between the other end of the first coupling part and the other end of the second coupling part.
